(19) United States
(12) Patent Application Publication
(10) Pub. No.: US 2012/0136910 A1
(43) Pub. Date: May 31, 2012

(54) Hardware And Method Of Numerical Integration

(75) Inventors: Brian L. Drummond, UIG (GB); Turhan F. Rahman, Duluth, MN (US)

(73) Assignee: COMPLEX DATA TECHNOLOGIES INC., Duluth, MN (US)

(21) Appl. No.: 13/255,692

(22) PCT Filed: Mar. 10, 2010
(86) PCT No.: PCT/US10/26772

§ 371 Date: Dec. 22, 2011

Related U.S. Application Data
(60) Provisional application No. 61/158,839, filed on Mar. 10, 2009.

(51) Int. Cl. G06F 7/38; G06F 17/14

(52) U.S. Cl. 708/400; 708/444; 708/443

(57) ABSTRACT

A system, method and chip for transforming data through a Rung-Kutta integration of a single point on a plane defined by X, Y, and Z values along X, Y and Z axes from a travel time data volume. The system includes at least one memory bank and at least one alternate memory bank and at least one single cycle Runge-Kutta travel time generator in communication with the memory banks. The single cycle Runge-Kutta travel time generator reads data from the at least one memory bank, and transforms the data by performing a Runge-Kutta integration on points of a plane defined by X, Y, and Z values along X, Y and Z axes in a travel time data volume and slowness data to generate another plane of values with the integration carried forward by a half step; and writes the data back to the at least one alternate memory bank.

### REFERENCE TO RELATED APPLICATIONS

This application claims one or more inventions which were disclosed in Provisional Application No. 61/158,839, filed Mar. 10, 2009, entitled “HARDWARE AND METHOD OF NUMERICAL INTEGRATION”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of computer systems and methods of processing data. More particularly, the invention pertains to a computer system that uses hardware acceleration in the form of an application-specific integrated circuit (ASIC) or a field-programmable gate array (FPGA) coprocessor to accelerate the processing of travel times.

2. Description of Related Art

Many applications in scientific computing involve the solution of differential equations to produce results that are used to make important decisions. For example, in the geosciences, the technique of ray tracing amounts to a numerical solution of the initial value problem for a system of differential equations. These ray equations describe characteristic lines of the eikonal equation. The solution results in a grid of travel times values, which along with seismic traces, are used as input to algorithms (e.g. Kirchhoff migration) to produce subsurface images of the Earth. These images play an important role in exploration and drilling decisions in the oil and gas industry.

Multiple traces of the Earth's subsurface are required to accurately determine where and if hydrocarbon reserves are present. Currently, multiple traces are obtained with data, and sent to computers which approximate the travel times of the sounds waves in order to produce subsurface images of the Earth. The computationally intensive nature of numerical differential equation solution reduces many of these decision procedures to batch processes. Consequently, speeding up differential equation solutions would enable many decision procedures to move toward becoming interactive and make use of trying many “what if” scenarios. Therefore, accelerating these computations has great economic value.

The present invention provides a means transforming the data and accelerating the computations on the data by providing a direct implementation in hardware for them, thus performing the transformation of data significantly faster than the equivalent software, as well as reducing the computational load on the central processing unit (CPU).

### SUMMARY OF THE INVENTION

A system, method and chip for transforming data through a Rung-Kutta integration of a single point on a plane defined by X, Y, and Z values along X, Y and Z axes from a travel time data volume. The system includes at least one memory bank and at least one alternate memory bank and at least one single cycle Runge-Kutta travel time generator in communication with the memory banks. The single cycle Runge-Kutta travel time generator reads data from the at least one memory bank, and transforms the data by performing a Runge-Kutta integration on points of a plane defined by X, Y, and Z values along X, Y and Z axes in a travel time data volume and slowness data to generate another plane of values with the integration carried forward by a half step; and writes the data back to the at least one alternate memory bank.

### BRIEF DESCRIPTION OF THE DRAWING

FIG. 1 shows a diagram in which each half-step of the second order of the Runge-Kutta integration is executed sequentially.

FIG. 2 shows a diagram in which each half-step of the second order of the Runge-Kutta integration is executed simultaneously.

FIG. 3 shows a detail of the single cycle Runge-Kutta travel time generator from FIGS. 1 and 2.

FIG. 4 shows a flow diagram of the steps of travel time generation performed by the travel time generator in FIGS. 1-3 of a first embodiment.

FIG. 5 shows the steps for calculating the X-Y plane for each Z.

FIG. 6 shows the steps for swapping the X and Z axes in the entire travel time volume.

FIG. 7 shows the steps for calculating the Z-Y plane for each X.

FIG. 8 shows the steps for swapping the Z and X axes in the entire travel time volume.

FIG. 9 shows the steps for calculating the X-Z plane for each Y.

FIG. 10 shows a flow diagram of the steps of travel time generation performed by the travel time generator in FIGS. 1-3 of a second embodiment.

FIG. 11 shows the steps for calculating the X-Z plane for each Y and writing back to memory as the Z-X plane.

FIG. 12 shows the steps for calculating the Z-X plane for each Y and writing back to memory as the X-Z plane.

FIG. 13 shows a schematic of the memory interface relative to the Runge-Kutta travel time generator.

### DETAILED DESCRIPTION OF THE INVENTION

The present invention is a system that implements a method of using second-order Runge-Kutta integration to generate travel times from the source trace data and the velocity model. Preferably, the method is implemented in special-purpose hardware such as a dedicated integrated circuit (“chip”).

The Runge-Kutta integration has been ported from an original software implementation into hardware, initially to a field programmable gate array (FPGA) such as the Virtex-II Pro or Virtex-5 FPGA devices from Xilinx, but it will be understood that this is also suitable for incorporation into other hardware configurations including application specific integrated circuits (ASIC) for high volume applications. The FPGA has the advantage that the design may be updated, or the same hardware may be reconfigured to perform other applications. However, the ASIC may offer high performance, and lower cost for large production volumes.

The Runge-Kutta (numerical) integration implemented into hardware discussed above may be used to process data for numerous applications. In one example, the numerical integration implemented into hardware is used to process travel time values associated with the seismic data of the subsurface of the Earth.

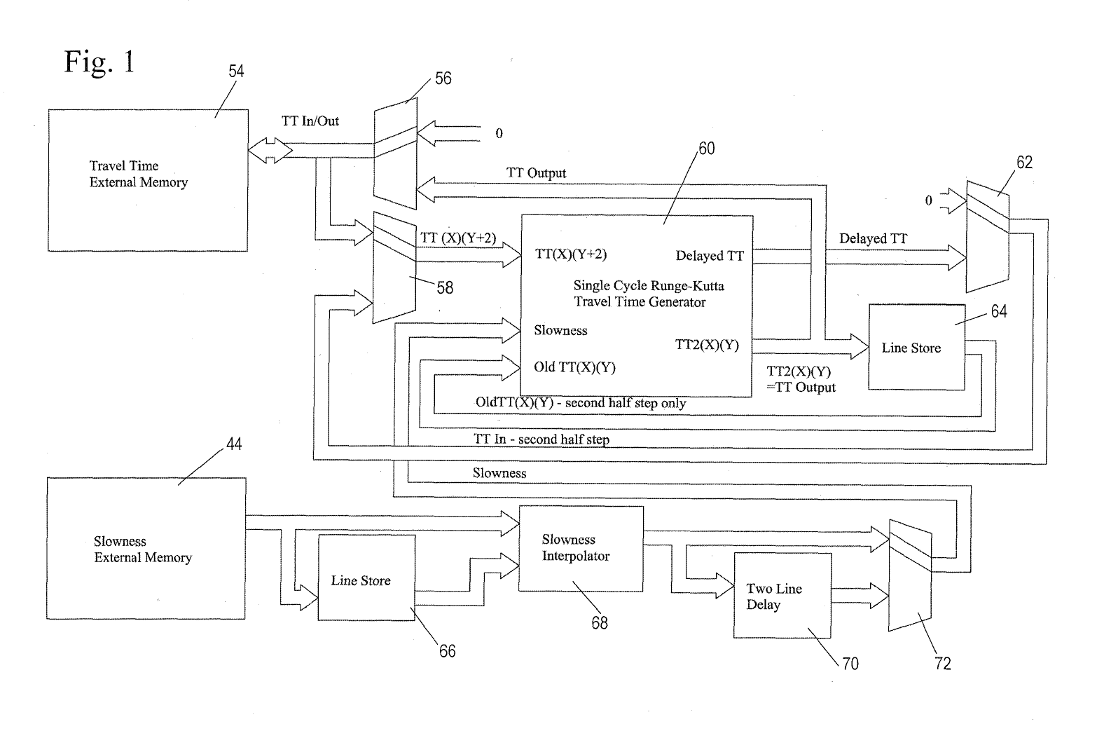

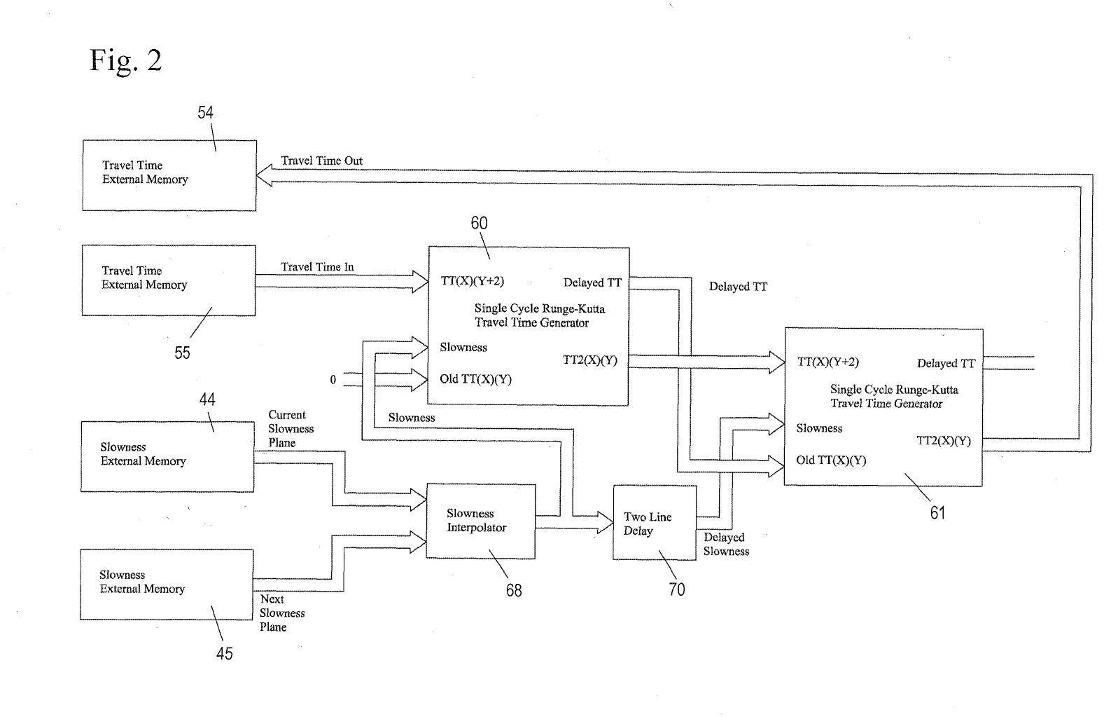

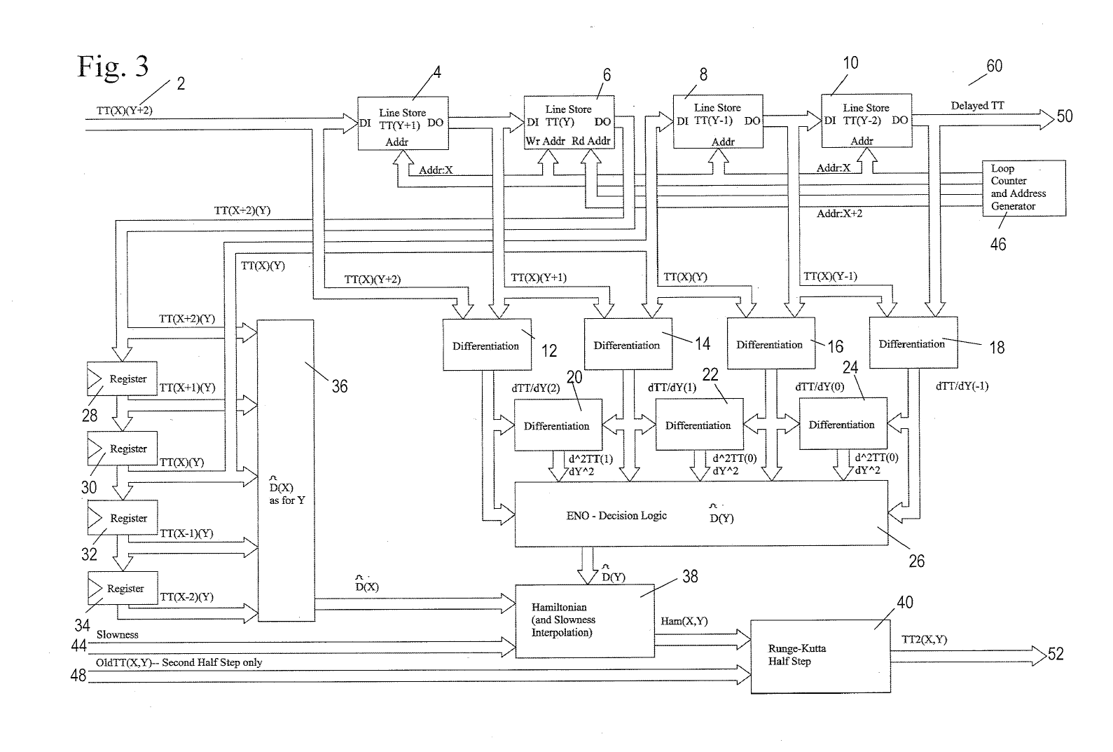

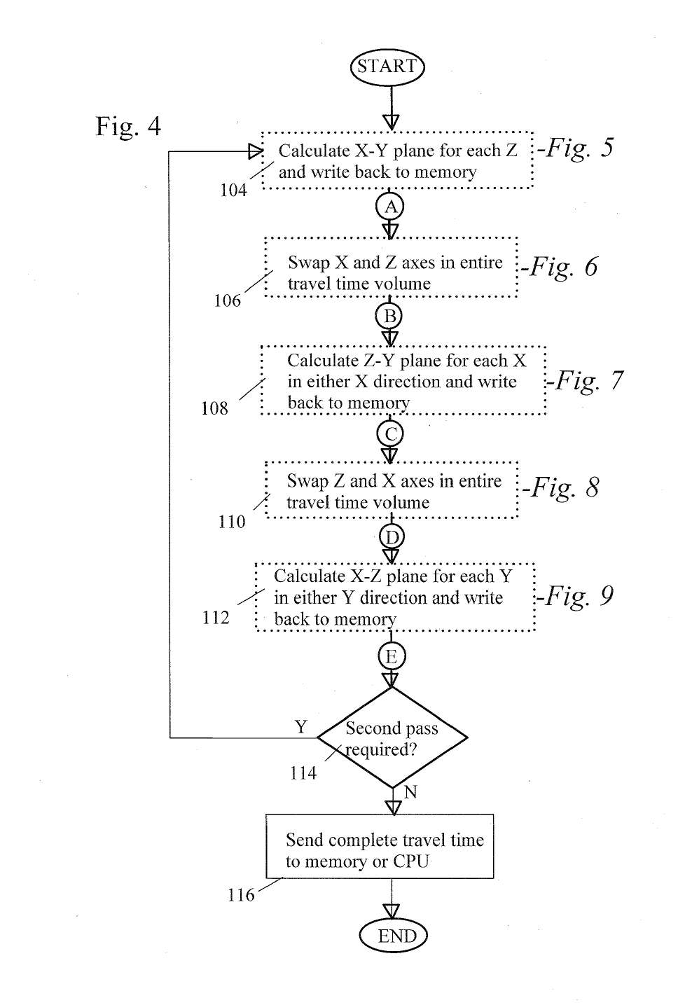

FIG. 3 shows the structure of the Runge-Kutta core. The core performs a Runge-Kutta integration on a plane of travel time values from a source of trace data and a velocity model, to generate another plane of values with the integration carried forward (i.e. downwards, in increasing depth) by a half step as described in FIGS. 4-12. Thus, either two of these cores are required to advance the integration by one step as shown in FIG. 2, or two passes through the same core as shown in FIG. 1. This allows some tradeoff to be made between hardware cost and speed. In other words, the Runge-Kutta integration is performed on both half steps on a 1D vector of data before proceeding to the next 1D vector. It is necessary that each vector have its two nearest neighbors in each direction to be held in a pipeline structure, since the second order approximations require three data points. Therefore, simultaneous access to five vectors is required.

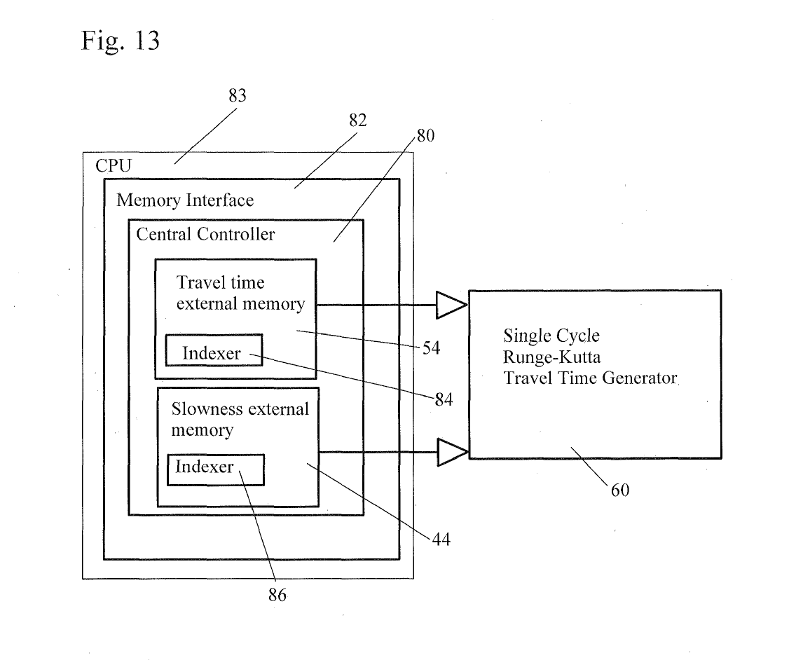

The single cycle Runge-Kutta travel time generator 60, 61 interacts with a memory interface 82 which includes a central controller 80 that controls the travel time external memory 54, 55 and the slowness external memory 44, 45 as shown in FIG. 13. The central controller 80 is controlled by the memory interface 82 which interacts with a central processing unit (CPU) 83. The central processing unit 83 can write to and read from the registers that are controlled by the central controller 80. The single cycle Runge-Kutta travel time generator block 60 of FIG. 3 receives an input of travel times from a current plane present in a travel time external memory 54, 55 and local slowness values from a velocity model present in the slowness external memory 44, 45.

The travel time external memory 54, 55 is preferably a fast access memory such as SSRAM. Static memory, such as SSRAM, offers fast access to any address within its memory space. However, it has limited capacity, here assumed to be 1 million words by way of an example. The fast random access memory has an indexer 84 and register map which is controlled by the central controller 80. The fast random access memory counts in units of 1 for X for calculating the X-Y plane, for Z in calculating the X-Z plane for Y, and for Z in calculating the Z-Y plane. The fast random access memory counts in units of X size for Y in calculating X-Y plane for each Z and for Z in calculating the X-Z plane for each Y. The fast random access memory counts in units of 1 and X size or Z size for swapping the X and Z axes or the Z and X axes in the travel time volume of data. The X and Z axes in the entire travel time data may be swapped or just a portion of the data may be swapped depending on the application.

The slowness external memory 44, 45 is preferably bulk memory such as DDRAM. The bulk storage offers 1000 million words in a typical arrangement. It is arranged internally as a series of rows and columns, and accessing a location in this memory is a three stage process, which is potentially quite slow. First, a row is opened of access. Then, access to any location or column within that row (“column access”) is performed. At this stage, a series of column accesses may be performed at high speed; providing all the data are within the same row. Finally, the row is closed, by performing a “precharge” operation. There are enhancements to allow a small number of rows (typically four rows) to be opened at a time, but this clearly does not permit fast access to any memory location in the general case. Thus, the bulk memory is best suited to highly localized access patterns, such as linear accesses, for example iteration over X in the inner loop. The bulk memory has the same access time to the outer loops or the Y and Z axes.

The bulk memory has an indexer 86 and register map which is controlled by the central controller 80. The bulk memory does not increment the address in the inner direction and indexes row addresses either singly for the Y axis or by Y-size for the Z axis. The bulk memory can count and write simultaneously.

It should be noted that the travel time external memory 54, 55 is equivalent to the “alternate memory bank” and the slowness external memory 44, 45 is equivalent to the “memory bank” described relative to FIGS. 4-12. The Runge-Kutta travel time generator 60, 61 generates travel times with the integration advanced by a half step. In each clock cycle, the complete integration is performed on one travel time point.

Referring to FIG. 3, the travel time data 2 of TT(X)(Y+2) for the current plane is sent from the travel time external memory 54, 55 to the single cycle Runge-Kutta travel time generator 60. The travel time data 2 of TT(X)(Y+2) is an incoming vector of the current plane of travel time data and an additional four vectors are stored within the line stores 4, 6, 8, 10 for the Y axis calculation. Similarly, the incoming vector from the current plane of travel time data from line store 6 of TT(X+2)(Y) for the X-axis calculation is stored along with four other vectors in registers 28, 30, 32, and 34. By having an incoming vector available and four other vectors stored within either line stores or registers, simultaneous access to five vectors is available first and second order approximations.

Within the Runge-Kutta travel time generator 60, the travel time data TT(X)(Y+2) is sent to a line store 4 as direct input and to a differentiation block 12. The line store 4 receives an X address Addr X from the Loop Counter and Address Generator 46. The direct output of TT(X)(Y+1) from line store 4 is sent to the line store 6 as direct input and to the differentiation block 12 and differentiation block 14. The line store 6 receives an X write address Addr X W Addr and a X+2 read address Addr X+2 Rd Addr. The X+2 read address sent to the line store 6 allows the vector stored in line store 6 of TT(X+2)(Y) to be read at least two cycles ahead of the other vectors in the line store and produce the output sent to the register 28 used for the X axis calculation. By having a separate write address W addr and read address Rd Addr inputs from the Loop counter and Address Generator 46 to the line store 6, the write address can be separately computed from the read addresses without impacting the read addresses.

The direct output TT(X+2)(Y) of line store 6 is sent to register 28 and the \hat{D}(X) as to Y block 36. The output of TT(X+1)(Y) from register 28 is sent to \hat{D}(X) as for Y block 36 and to the next register 30 in the pipeline. The output of TT(X)(Y) from register 30 is sent to \hat{D}(X) as for Y block 36 and to the next register 32 in the pipeline. The output of TT(X−1)(Y) from register 32 is sent to \hat{D}(X) as for Y block 36 and the next register 34 in the pipeline. The output of TT(X−2)(Y) is sent from the register 34 to the \hat{D}(X) as for Y block 36. It should be noted that while not shown in FIG. 3, the outputs from the registers 28, 30, 32, and 34 are differentiating using differentiation blocks (not shown) similar to that of differentiation blocks 12, 14, 16, 18, 20, 22, and 24 shown in FIG. 3 for the Y axis calculations. The \hat{D}(X) as for Y block 36 examines a sequence of five differentiated travel time values spaced equally along the X axis in the current plane of values, compares the derivatives of the values and deduces a direction of wave front propagation at a central point. The output of \hat{D}(X) from the \hat{D}(X) as for Y block 36 is sent to the Hamiltonian (and Slowness Interpolation) block 38.

The output of TT(X)(Y) from register 30 is also sent as direct input to line store 8 and to differentiation block 14 and 16. The line store 8 receives an X address, Addr X from the Loop Counter and Address Generator 46. The direct output of line store 8 is sent to differentiation blocks 16 and 18 and as direct input to line store 10. Line store 10 receives an X address, Addr X from the Loop Counter and Address Generator 46. The direct output of line store 10 is TT(X)(Y−2) and Delayed TT. Delayed TT is the inputted travel time TT(X)(Y+2) delayed in a succession of line stores 4, 6, 8, and 10. Delayed TT is outputted from the Runge-Kutta travel time generator 60 block and TT(X)(Y−2) is sent to the differentiation block 18.

The output dTT/dY(2) of differentiation block 12 is sent to differentiation block 20 and ENO decision Logic block 26. The output dTT/dY(1) from differentiation block 14 is sent to differentiation blocks 20 and 22, and the ENO decision Logic block 26. The output dTT/dY(0) from differentiation block 16 is sent to differentiation blocks 22 and 24, and the ENO decision Logic block 26. The output dTT/dY(−1) from differentiation block 18 is sent to differentiation block 24, and the ENO decision Logic block 26. In turn, the output of d²TT(1) dY², d²TT(0) dY², and d²TT(0) dY² from differentiation blocks 20, 22, and 24 respectively are all sent to ENO decision logic block 26. The ENO decision Logic block 36 examines a sequence of five differentiated travel time values spaced equally along the Y axis in the current plane of values, compares the derivatives of the values and deduces a direction of wave front propagation at a central point

The output \hat{D}(Y) of the ENO decision logic block 26 is sent to the Hamiltonian (and Slowness Interpolation) block 38. The Hamiltonian (and Slowness Interpolation) block 38 also receives slowness data 44 from the velocity model that is stored in the slowness external memory 44. The Hamiltonian (and Slowness Interpolation) block 38 computes the time taken for the wave front to reach the next plane from the output \hat{D}(Y) of the ENO decision logic block 26 and the slowness data 44 from the velocity model that is stored in the slowness external memory 44 using the relationship of Time=Distance/Velocity. The output Ham(X, Y) of the Hamiltonian (and Slowness Interpolation) block 38 is sent to the Runge-Kutta Half Step block 40 and the output of TT2(X,Y) 52 is sent to and written to the memory for the trace being calculated. It should be noted that slowness data is not stored for every point within the travel time volume at which integration is performed. Therefore, a local value of slowness is computed by the slowness interpolation portion of block 38 between slowness values at neighboring points.

If two single cycle Runge-Kutta travel time generators 60, 61 are each being used to compute a half step, the old travel time data, OldTT(X,Y) would be inputted into the Runge-Kutta Half Step block 40 to output the other half step travel time data as shown in FIG. 2. The second Runge-Kutta travel time generator 61 is preferably the same as the first Runge-Kutta travel time generator 60.

It should be noted that by reading the current (past) plane in one half step, the next plane in the other half step and interpolating between them, there may not be any data to start with. If only one slowness external memory is present and thus only one slowness data value may be read at a time, interpolation cannot take place, since two values are required. Normally, the second value is supplied from a line store or other memory such as the travel time external memory, however at the start of travel time generation no values may have been previously store. In that case, the first half step and needs to be on a plane boundary to that no interpolation is necessary (e.g. the single value can be read directly). By using the half steps, there is a limitation on where incremental travel time generation can start. In other words the travel time increments must start on a velocity model grid boundary.

The term \hat{D} within the application denotes a predicted value for a distance along an axis, either X or Y, and thus the horizontal component of the wave front direction. This predicted value may be the derivative in X or Y relative to Z of the direction of the propagating wave.

FIGS. 4-12 show the transformation of the travel times from the current plane and local slowness values from the velocity model to travel times advanced by a half step carried out by in a first embodiment and a second embodiment.

The downward integration alone is not sufficiently accurate throughout the entire volume of data. Accuracy in the outer regions of the volume of data (where horizontal displacement from the initial shot location is relatively large) requires integration along each horizontal axis; this integration pass will be referred to as a “sidesweep”.

The single cycle Runge-Kutta travel time generator 60, 61 are used for the sidesweeps. Using sidesweeps improves the accuracy in peripheral regions of the travel time volume. However, the indexing described above, implies that computations take place across an X-Y plane, to advance the computation in the (+)Z direction. Sidesweeps require following this process with alternately computing X-Z planes to advance in the (+ and −) Y direction, and Y-Z planes to advance in the (+ and −) X direction. It should be noted that advancing in the −Z direction (an upward sweep) is not required in order to provide an accurate integration of the travel times. Sidesweeps are described in greater detail in FIGS. 4-12.

This access pattern restriction of the bulk memory means that the downward sweep (iterate over X, then over Y, then outermost over Z) can be directly followed by the Y axis sidesweeps (iterate over X, then over Z, then over (+/−) Y but the X axis sidesweeps cannot be accomplished in the same way. This is because the X axis sidesweep requires that the X axis be the major axis, and there it cannot be the minor axis as is necessary for high performance sequential access. Using the single cycle architecture of U.S. Pat. No. 6,237,021 entitled, “METHOD AND APPARATUS FOR THE EFFICIENT PROCESSING OF DATA-INTENSIVE APPLICATIONS”, issued May 22, 2001, which is hereby incorporated by reference, the major axes of iteration (either Z or Y) can utilize bulk dynamic memory while the remaining (minor) axes of iteration utilizes fast access static memory.

In one embodiment of the present invention, in order to overcome the access pattern restriction associated with the bulk memory, the travel time volume of data (and relevant section of slowness data) is copied, swapping axes in the process, before the X axis sweeps; and to reverse the process afterwards (because a second pass over the entire volume is normally required for accuracy). Therefore, the Y axis becomes the minor axis for the X axis sidesweep. This swap is possible because an entire X-Y plane can be stored in static memory, capable of fast access along either axis. Each plane in turn is read in its entirety into static memory, with the X axis as its minor axis. It is then written back to bulk (dynamic) memory with the Y axis as its minor axis. It is possible to combine this axis swap with other processing, so the axis swap need not consume any additional time. It should be noted that this technique may be extended to transform any of the three axes to be the minor axis for fastest access to data in that axis, or to allow any of the three axis to be the major axis for algorithmic considerations. However, the current implantation only requires that the X and Y axes be treated as the minor axis to cover all three axes as the major axis. These steps will be described in more detail below.

### FIG. 4

### Overall Method Description

### First Embodiment

104. Calculated the X-Y plane for each Z and write back to memory.
   The travel time is copied from a memory bank, preferably bulk memory such as DDR memory to an alternate memory bank or the travel time external memory 54, 55 shown in FIGS. 1 and 2 which is preferably fast access memory, such as SSRAM memory. Since the alternate memory bank is a relatively small fast access memory bank, it cannot contain an entire travel time volume. Therefore, after each X-Y plane is calculated for each Z in step 104, the data is copied back to the memory bank or bulk memory. The data in the memory bank is used as a starting point for generating the next Z-plane. Thus, the entire travel time volume is built up in the bulk memory and one plane is stored in the alternate memory bank.
   For the first plane of the first sweep of a new travel time volume, there is no data to load from the memory bank. Instead, a CPU will initialize the relevant values directly into the alternate memory bank.
   Since the alternate memory bank is a relatively small fast access memory bank, it cannot contain an entire travel time volume. Therefore, after each X-Y plane is calculated for each Z in step 104, the data is copied back to the memory bank or bulk memory.
106. Then, the X and Z axes of the travel time volume are swapped.
   The travel time volume that was calculated in step 104 and copied back to the memory bank is loaded into the alternate memory bank and then written back to a different part of the memory bank, swapping the X and Z axes.
108. The Z-Y plane for each X is calculated in either X direction and written back to memory.
   The term “either X direction” refers to two directions, increasing X coordinates or decreasing X coordinates. Since the alternate memory bank is a relatively small fast access memory bank, it cannot contain an entire travel time volume. Therefore, after each Z-Y plane is calculated for each X in step 108, the data is copied back to the memory bank or bulk memory.
110. Then the Z and X axes of the travel time volume are swapped
   The travel time volume that was calculated in step 108 and copied back to the memory bank is loaded into the alternate memory bank and then written back to a different part of the memory bank, swapping the Z and X axes.
112. Next, the X-Z-plane for each Y in either direction is calculated and write back to memory.
   The term “either Y direction” refers to two directions, increasing Y coordinates or decreasing Y coordinates.
116 Send complete travel time to memory or CPU
   If the other half step has not yet been completed, the data from step 112 is sent back to step 104 for another pass. If the full step has been completed, then the travel time data is sent to external memory or the CPU.

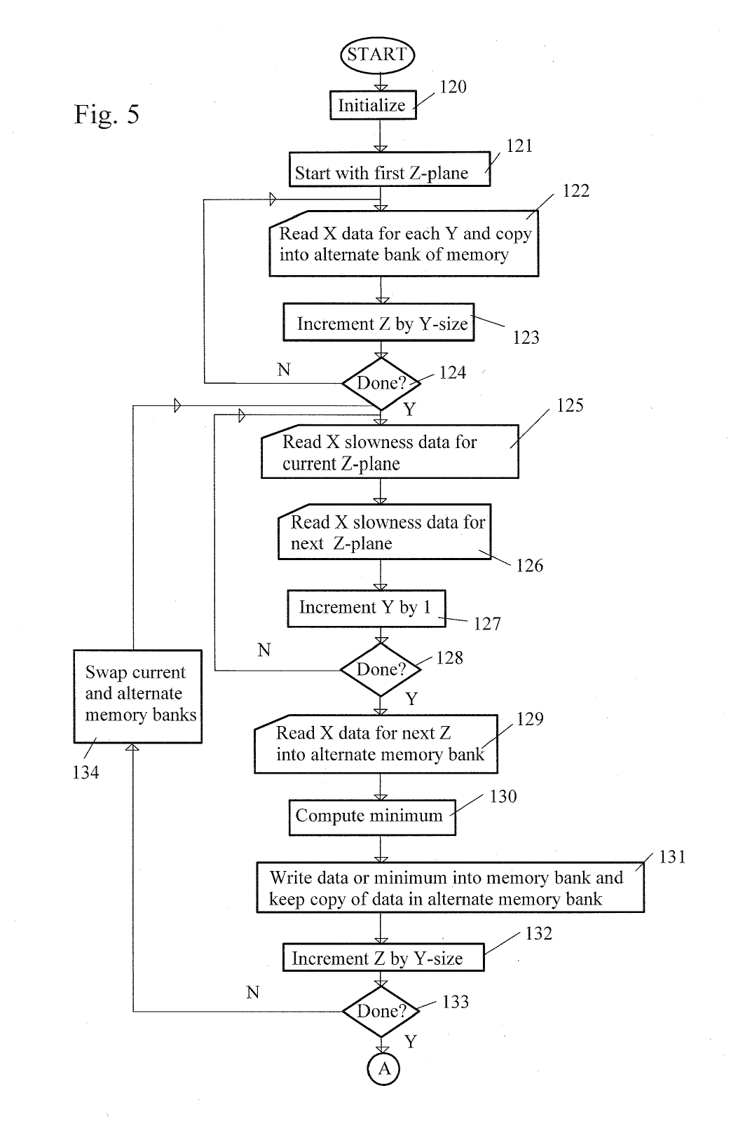

### FIGS. 5-9

### Details for blocks 104-112 in FIG. 4

### FIG. 5

### Block 104 Detail

### Steps for Calculating the X-Y Plane for Each Z and Write Back to Memory

120. In a first step, the data is initialized

### First Z-Plane Loop:

121. Then, starting with the first Z-plane,
122. read the X data for each Y and copy into alternate memory bank.
123. increment 123 by Z, Y-size.
124. determine 124 whether all X data for each Y has been read. If not done reading the X data for each Y, return to step 122. If done reading X data for each Y, continue.

### Current Z-Plane Loop:

Read Loop:
125. read X slowness data for current Z-plane.
126. read X slowness data for next Z-plane.
127. Increment Y by 1.
128. If not done 128, return to step 125. If done 128, continue.

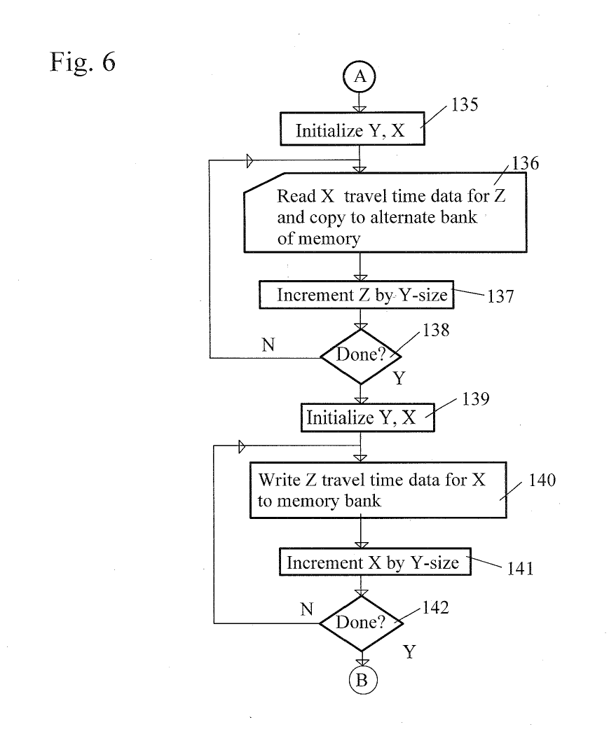

Write Loop:
129. read X data for next Z into alternate memory bank.
130. compute the minimum.
   The minimum computed is the minimum between the previously stored data and that newly calculated data of the current plane for each point within the plane. The minimum data is stored in the alternate memory bank, preferably fast access memory, such as SSRAM. The minimum data is used as the start of a new plane and is also written back to a memory bank, preferably bulk memory, such as DDRAM.
131. Write data or minimum into memory bank and keep a copy of the data in the alternate memory bank
   The minimum is written to both the alternate memory bank, preferably fast access memory such as SSRAM and the memory bank, preferably bulk memory, such as DDRAM. The minimum data is used as the start of a new plane.
132. Increment 132 Z by Y-size.
133. If all Y increments are not done, swap current and alternate memory banks in step 134 and return to step 125.
133. If done, continue on to step 106 (FIG. 6) of swapping X and Z axes in entire travel time volume.
134. Swap current and alternate memory banks.

### FIG. 6

### Block 106 Detail

### Steps for swapping the X and Z axes in the entire travel time volume

135. In a first step, initialize Y, X.

### Read X Travel Time Loop:

136. Read X travel time data for Z and copy to alternate memory bank.
137 Increment 137 Z by Y-size.
   If X increments from step 141 are different that Z increments in step 137, the data is written to separate entries within the memory bank.
138. Determine whether all X travel time data for Z has been read. If not done reading the X data for each Z, return to step 136. If done reading X data for each Z continue.

### Write Z Travel Time Loop:

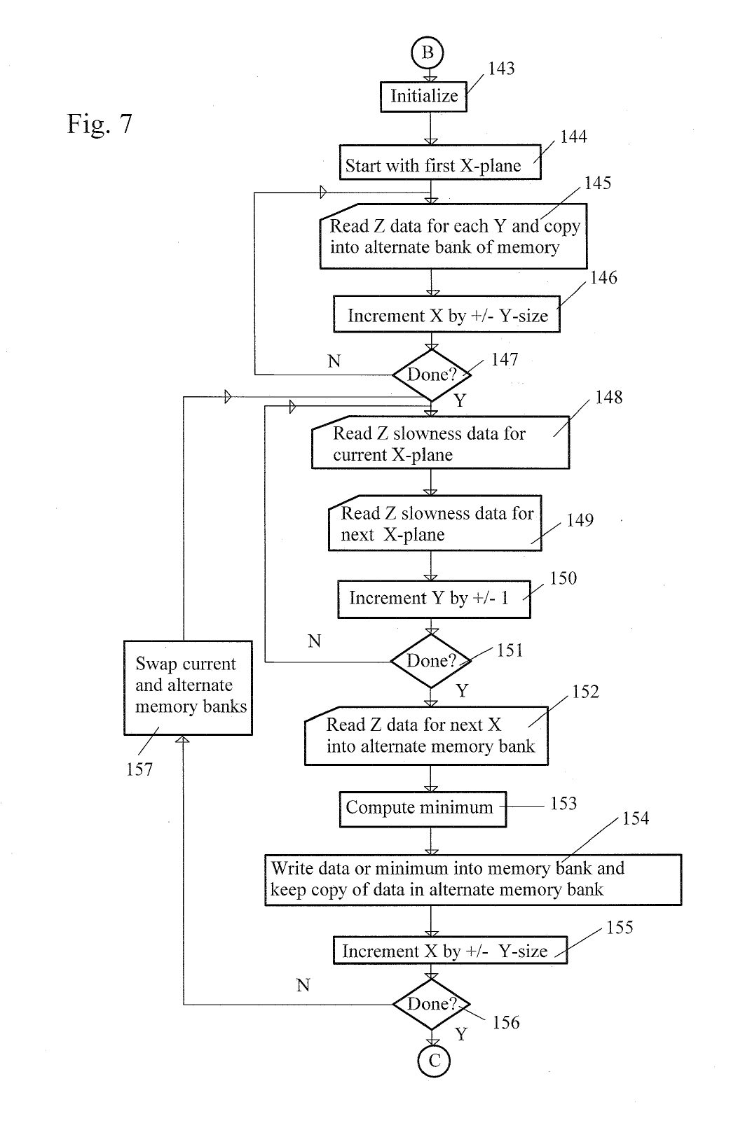

139. Initialize Y and X.
140. Write Z travel time data for X to memory bank.
141 Then increment 141 X by Y-size.
   If X increments from step 141 are different that Z increments in step 137, the data is written to separate entries within the memory bank.
142. Determined whether all Z travel time data for X has been written to memory. If not done writing Z travel time for each X, return to step 140. If done writing Z travel time for each X continue on to step 108 (FIG. 7) of calculating the Z-Y plane for each X in either X direction.

### FIG. 7

### Block 108 Detail

### Steps for Calculating the Z-Y Plane for Each X in Either X Direction and Write Back to Memory

143. In a first step, the data is initialized

### First X-Plane Loop:

144. Then, starting with the first X-plane,
145. read the Z data for each Y and copy into alternate memory bank.
146. increment 123 by X, +/−Y-size.
   The term “+/−” is defined as either increasing or decreasing the variable immediately after.
147. determine whether all Z data for each Y has been read. If not done reading the Z data for each Y, return to step 144. If done reading Z data for each Y, continue.

### Current X-Plane Loop:

Read Loop:
148. read Z slowness data for current X-plane.
149. read Z slowness data for next X-plane.
150. Increment Y by +/−1.
   The term “+/−” is defined as either increasing or decreasing the variable immediately after
151. If not done, return to step 148. If done, continue.

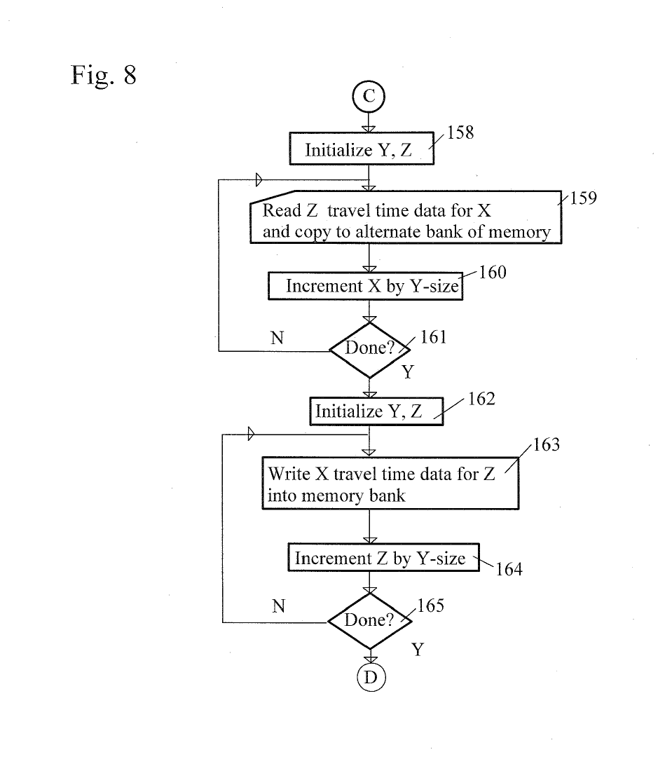

Write Loop:
152. read Z data for next X into alternate memory bank.
153. compute the minimum.
   The minimum computed is the minimum between the previously stored data and that newly calculated data of the current plane for each point within the plane. The minimum data is stored in the alternate memory bank, preferably fast access memory, such as SSRAM. The minimum data is used as the start of a new plane and is also written back to a memory bank, preferably bulk memory, such as DDRAM.
154. Write data or minimum into memory bank and keep copy of data in the alternate memory bank
   The minimum is written to both the alternate memory bank, preferably fast access memory such as SSRAM and the memory bank, preferably bulk memory, such as DDRAM. The minimum data is used as the start of a new plane.
155. Increment X by +/−Y-size.
   The term “+/−” is defined as either increasing or decreasing the variable immediately after
156. If all Y increments are not done, swap current and alternate memory banks in step 157 and return to step 148. If done, continue on to step 110 (FIG. 8) of swapping Z and X axes in entire travel time volume.
157. Swap current and alternate memory banks.

### FIG. 8

### Block 110 Detail

### Steps for Swapping the Z and X Axes in the Entire Travel Time Volume 110

158. In a first step, initialize Y, X.

### Read Z Travel Time Loop:

159. Read Z travel time data for X and copy to alternate bank of memory.
160 Increment X by Y-size.
161. Determine whether all Z travel time data for X has been read. If not done reading the Z data for each X, return to step 159. If done reading Z data for each X continue.

### Write X Travel Time Loop:

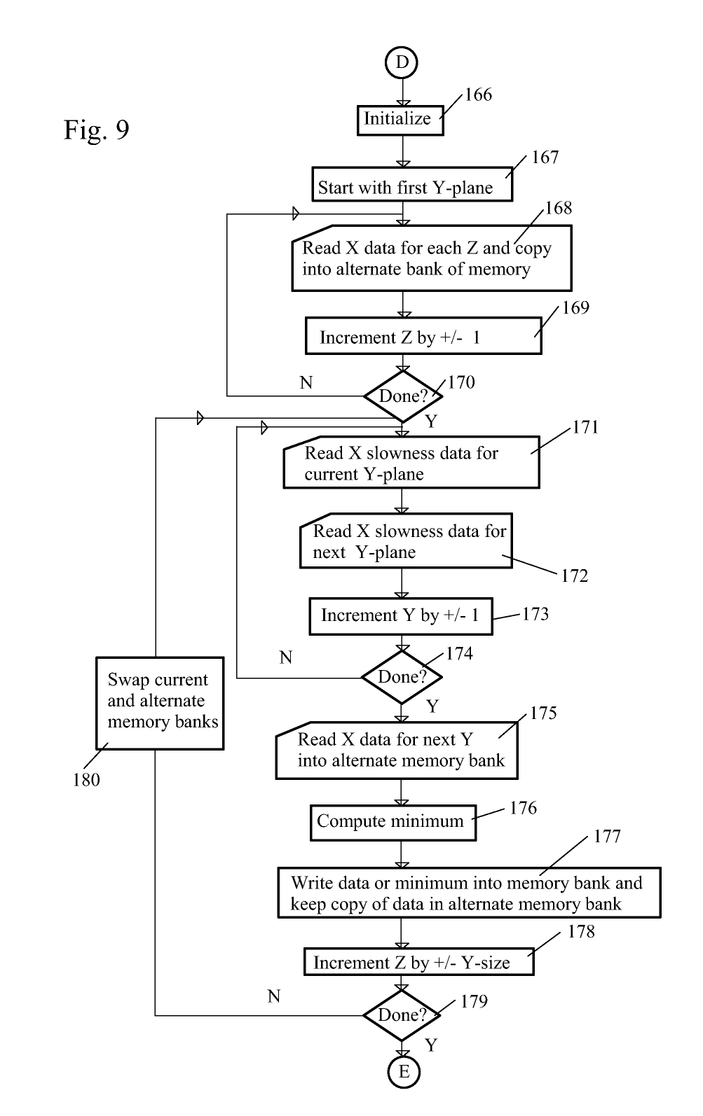

162. Initialize Y and Z.
163. Write X travel time data for Z to memory bank.
164 Then increment Z by Y-size.
165. Determined whether all X travel time data for Z has been written to memory. If not done writing X travel time for each Z, return to step 163. If done writing X travel time for each Z, continue on to step 112 (FIG. 9), of calculating the X-Z plane for each Y in either Y direction.

### FIG. 9

### Block 112 Detail

### Steps for Calculating the X-Z Plane for Each Y in Either Y Direction, and Write Back to Memory

166. In a first step, the data is initialized

### First Z-Plane Loop:

167. Then, starting with the first Y-plane,
168. read the X data for each Z and copy into alternate memory bank
169. increment by Z, +/−1
   The term “+/−” is defined as either increasing or decreasing the variable immediately after
170. determine whether all X data for each Z has been read. If not done reading the X data for each Z, return to step 168. If done reading X data for each Z, continue.

### Current Z-Plane Loop:

Read Loop:
171. read X slowness data for current Y-plane.
172. read X slowness data for next Y-plane.
173. Increment Y by +/−1.
   The term “+/−” is defined as either increasing or decreasing the variable immediately after
174. If not done, return to step 171. If done, continue.

Write Loop:
175. read X data for next Y into alternate memory bank
176. compute the minimum.
   The minimum computed is the minimum between the previously stored data and that newly calculated data of the current plane for each point within the plane. The minimum data is stored in the alternate memory bank, preferably fast access memory, such as SSRAM. The minimum data is used as the start of a new plane and is also written back to a memory bank, preferably bulk memory, such as DDRAM.
177. Write data or minimum into memory bank and keep a copy in alternate memory bank
   The minimum is written to both the alternate memory bank, preferably fast access memory such as SSRAM and the memory bank, preferably bulk memory, such as DDRAM. The minimum data is used as the start of a new plane.
178. Increment Z by +/−Y-size.
   The term “+/−” is defined as either increasing or decreasing the variable immediately after
179. If all Z increments are not done, swap current and alternate memory banks in step 180 and return to step 171. If done, continue on to step 114 (FIG. 4) of determining whether a second pass through the data is needed.
180. Swap current and alternate memory banks.

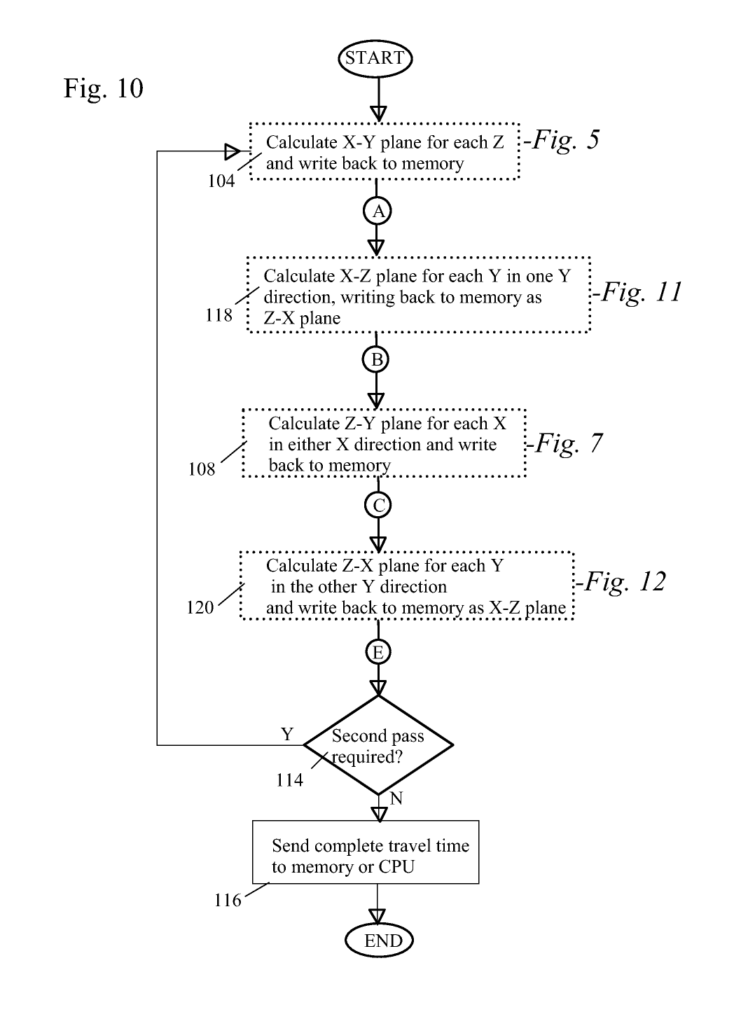

### FIG. 10

### Overall Method Description

### Second Embodiment

Alternatively in a second embodiment, the axis swaps are combined with the Y axis calculations to decrease processing time.
104. The X-Y plane is calculated for each Z and written back to memory.
   The travel time is copied from a memory bank, preferably bulk memory such as DDR memory to an alternate memory bank or the travel time external memory 54, 55 shown in FIGS. 1 and 2 which is preferably fast access memory, such as SSRAM memory. Since the alternate memory bank is a relatively small fast access memory bank, it cannot contain an entire travel time volume. Therefore, after each X-Y plane is calculated for each Z in step 104, the data is copied back to the memory bank or bulk memory. The data in the memory bank is used as a starting point for generating the next Z-plane. Thus, the entire travel time volume is built up in the bulk memory and one plane is stored in the alternate memory bank.
   For the first plane of the first sweep of a new travel time volume, there is no data to load from the memory bank. Instead, a CPU will initialize the relevant values directly into the alternate memory bank.
   Since the alternate memory bank is a relatively small fast access memory bank, it cannot contain an entire travel time volume. Therefore, after each X-Y plane is calculated for each Z in step 104, the data is copied back to the memory bank or bulk memory.
118. Calculate X-Z plane for each Y in one Y direction and write back to memory as the Z-X plane.
108. The Z-Y plane for each X is calculated in either X direction and written back to memory.
   The term “either X direction” refers to two directions, increasing X coordinates or decreasing X coordinates. Since the alternate memory bank is a relatively small fast access memory bank, it cannot contain an entire travel time volume. Therefore, after each Z-Y plane is calculated for each X in step 108, the data is copied back to the memory bank or bulk memory.
120. Calculate the Z-X plane for each Y in the other Y direction and write back to memory as the X-Z plane.
116 Send complete travel time to memory or CPU
   If the other half step has not yet been completed, the data from step 112 is sent back to step 104 for another pass. If the full step has been completed, then the travel time data is sent to external memory or the CPU.

The details of blocks 104, 108 and 116 are discussed above and are hereby repeated here by reference. The detail of blocks 118 and 120 is shown below.

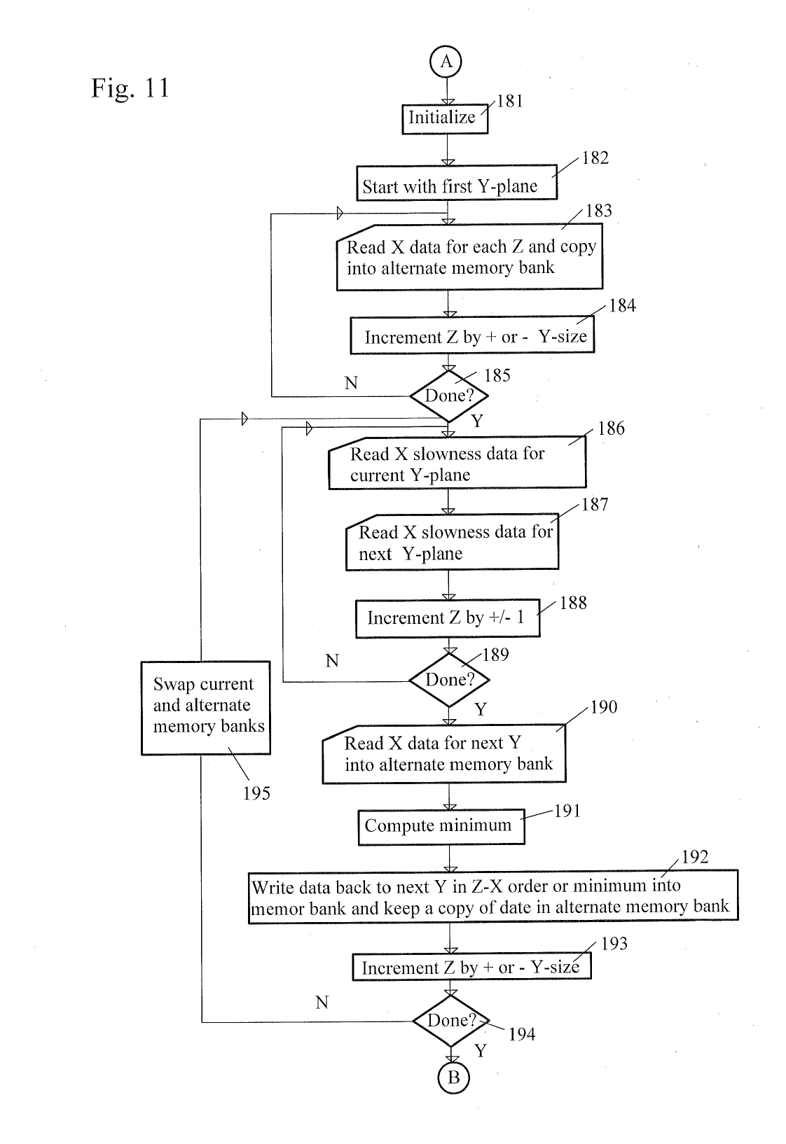

### FIG. 11

### Block 118 Detail

### Steps for Calculating the X-Z Plane for Each Y in One Y Direction and Writing Back to Memory as Z-X Plane

181. In a first step, the data is initialized

### First Y-Plane Loop:

182. Then, starting with the first X-plane,
183. read the X data for each Z and copy into alternate memory bank.
184. increment 123 by Z by + or −Y-size.
185. determine whether all X data for each Z has been read. If not done reading the X data for each Z, return to step 183. If done reading X data for each Z, continue.

### Current Y-Plane Loop:

Read Loop:
186. read X slowness data for current Y-plane.
187. read X slowness data for next Y-plane.
188. Increment Z by +/−1.
   The term “+/−” is defined as either increasing or decreasing the variable immediately after
189. If not done, return to step 186. If done, continue.

Write Loop:
190. read X data for next Y into alternate memory bank.
191. compute the minimum.
   The minimum computed is the minimum between the previously stored data and that newly calculated data of the current plane for each point within the plane. The minimum data is stored in the alternate memory bank, preferably fast access memory, such as SSRAM. The minimum data is used as the start of a new plane and is also written back to a memory bank, preferably bulk memory, such as DDRAM.
192. Write data back to next Y in Z-X order or minimum into memory bank and keep a copy in alternate memory bank
   The minimum is written to both the alternate memory bank, preferably fast access memory such as SSRAM and the memory bank, preferably bulk memory, such as DDRAM. The minimum data is used as the start of a new plane.
193. Increment Z by + or −Y-size.
194. If all Z increments are not done, swap current and alternate memory banks in step 195 and return to step 186. If done, continue on to step 116 (FIG. 11) of calculating Z-X plane for each Y in either Y direction, writing back to memory as X-Z plane.
195. Swap current and alternate memory banks.

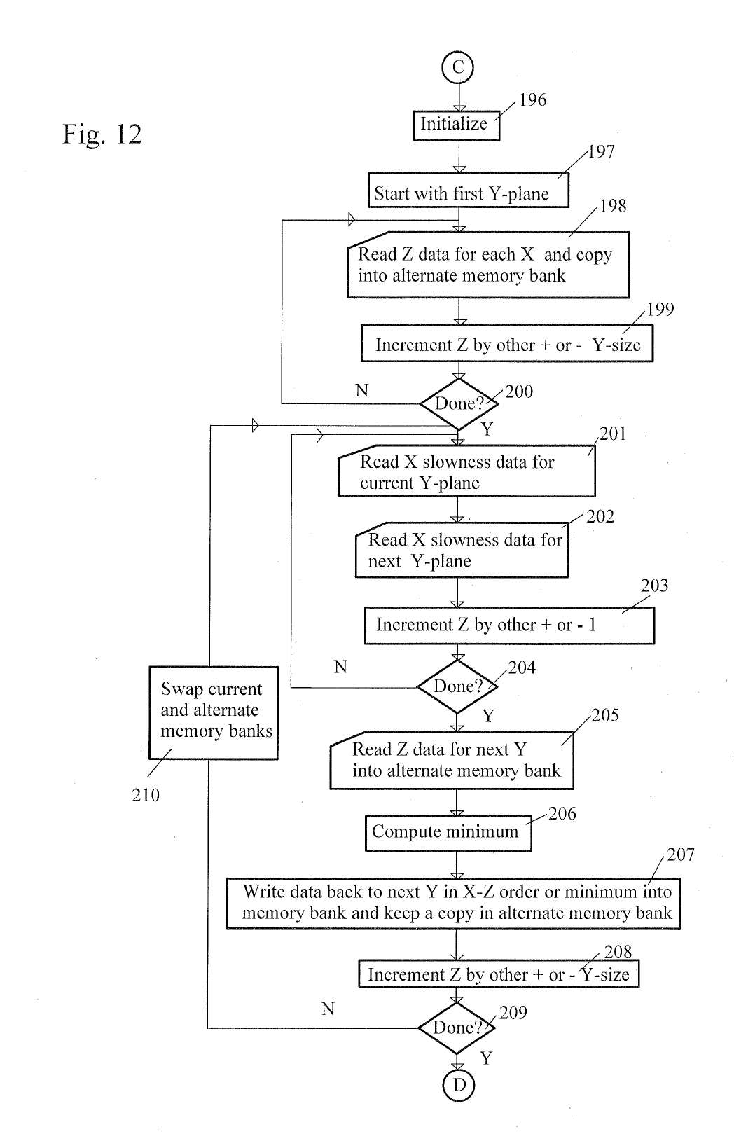

### FIG. 12

### Block 120 Detail

### Steps for Calculating the Z-X Plane for Each Y in Other Y Direction and Writing Back to memory as X-Z plane

196. In a first step, the data is initialized

### First Y-Plane Loop:

197. Then, starting with the first Y-plane,
198. read the Z data for each X and copy into alternate memory bank.
199. increment 123 by Z by other + or −Y-size.
200. determine whether all Z data for each X has been read. If not done reading the Z data for each X, return to step 198. If done reading Z data for each X, continue.

### Current Y-Plane Loop:

Read Loop:
201. read Z slowness data for current Y-plane.
202. read Z slowness data for next Y-plane.
203. Increment Z by +/−1
   The term “+/−” is defined as either increasing or decreasing the variable immediately after
204. If not done, return to step 201. If done, continue.

Write Loop:
205. read Z data for next Y into alternate memory bank.
206. compute the minimum.
   The minimum computed is the minimum between the previously stored data and that newly calculated data of the current plane for each point within the plane. The minimum data is stored in the alternate memory bank, preferably fast access memory, such as SSRAM. The minimum data is used as the start of a new plane and is also written back to a memory bank, preferably bulk memory, such as DDRAM.
207. Write data back to next Y in X-Z order or minimum into memory bank and keep a copy in alternate memory bank
   The minimum is written to both the alternate memory bank, preferably fast access memory such as SSRAM and the memory bank, preferably bulk memory, such as DDRAM. The minimum data is used as the start of a new plane.
208. Increment Z by other + or −Y-size.
209. If all Z increments are not done, swap current and alternate memory banks in step 210 and return to step 201. If done, continue on to step 118 (FIG. 1-2) of sending data to another single cycle Runge-Kutta travel time generator as shown in FIG. 2 or a line store 64 and a multiplexer 62 as shown in FIG. 1.
210. Swap current and alternate memory banks.

### Detailed Description of Hardware Implementation of FIGS. 1-3

Two ways of using the single cycle travel time generator of FIG. 3 are illustrated in FIGS. 1 and 2. FIG. 1 shows a schematic of implementation using one the cores above; to implement the two Runge-Kutta half steps sequentially. FIG. 2 shows a schematic of implementation using two of the cores above to implement the two Runge-Kutta half steps in parallel.

Referring to FIG. 1, one single cycle Runge-Kutta travel time generator 60 is used implement two Runge-Kutta half steps sequentially. Travel time TT In/Out is sent from the travel time external memory 54 to a multiplexer 58. The multiplexer 58 also receives the travel time from the second half step. The output TT(X)(Y+2) of the multiplexer 58 is sent to the single cycle Runge-Kutta travel time generator 60. Slowness data Slowness is sent from the slowness external memory 44 to a line store 66 and the slowness interpolator 68.

From the slowness interpolator 68, the slowness data Slowness is sent to a two line delay 70 and a multiplexer 72. From the multiplexer, slowness data is inputted into the single cycle Runge-Kutta travel time generator 60. The single cycle Runge-Kutta travel time generator 60 also receives the old travel time data OldTT(X)(Y) from the first half step during the second half step.

In the first half step, the single cycle Runge-Kutta travel time generator 60 transforms the input data TT(X)(Y+2) and Slowness into outputs TT2(X)(Y) and DelayedTT as shown in FIG. 3 and through the steps shown in FIGS. 4-9. The output TT2(X)(Y) is stored in a line store 64.

In the second half step, the single cycle Runge-Kutta travel time generator 60 transforms the input data, TT In-second half step only (combined in a multiplexer 58 with TT(X)(Y+2)), OldTT(X)(Y) and Slowness into output TT2(X)(Y) which is written back to travel time external memory 54. It should be noted that the input of OldTT(X)(Y) is simply the original input data TT(X)(Y+2) delayed by an appropriate number of line stores within the single cycle Runge-Kutta travel time generator 60 and that TT In-second half step only input is the output from the first half step.

It should be noted that in sequential mode, shown in FIG. 1, the travel time output TT2(X)(Y) is held in a single line store 64, feeding back into the input of multiplexer 58. Thus the first half step is performed, not over the entire plane, but over a single line (loop over X at constant Y, instead of loop over X and Y). Then the second half step is performed on the same line before proceeding to the first half step for the next Y value.

FIG. 2 schematic of implementation using two of the cores above to implement the two Runge-Kutta half steps in parallel. The first single cycle Runge-Kutta travel time generator 60 receives old travel time data Old TT (X)(Y) and travel time input TT(X)(Y+2) in from a first travel time external memory 55. Slowness data Current Slowness Plane and Next Slowness Plane from the current slowness plane and the next slowness plane, respectively from first and second slowness external memories 44, 45 are inputted into a slowness interpolator 68.

From the slowness interpolator 68, the slowness data Slowness is sent to the single cycle Runge-Kutta travel time generator 60 and to a two line delay 70. The single cycle Runge-Kutta travel time generator 60 outputs delayed travel time Delayed TT and TT2(X)(Y) which get sent to the second single cycle Runge-Kutta travel time generator 61 as input with delayed slowness Slowness from the two line delay 70.

The second cycle Runge-Kutta travel time generator 61 then outputs delayed travel time Delayed TT and TT2(X)(Y) which is sent to a second travel time external memory 54.

The numerical integration implemented into hardware may be used to process data for numerous applications and is not limited to the examples discussed herein.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of implementing a Runge-Kutta integration for generating a travel time half step for a single point defined by X, Y, and Z values along X, Y and Z axes in a travel time data volume comprising: at least one memory bank; at least one alternate memory bank; and at least one decision block interacting with the at least one memory bank and the at least one alternate memory bank comprising the steps of:
calculating an X-Y plane for each Z for a series of points in the X-Y plane of the travel time data volume and writing the X-Y plane for each Z back to the at least one memory bank and the at least one alternate memory bank;
swapping X and Z axes in the travel time data volume;
calculating an Z-Y plane for each X in either X direction for a series of points on the Z-Y plane of the travel time data volume and writing the Z-Y plane for each X in either X direction back to the at least one memory bank and the at least one alternate memory bank;
swapping Z and X axes in the travel time data volume;
calculating an X-Z plane for each Y in either Y direction for a series of points on the X-Z plane of the travel time data volume and writing the X-Z plane for each Y in either Y direction back to the at least one memory bank and the at least one alternate memory bank;
if a second half step for single point has not been calculated, return to calculating an X-Y plane for each Z for a series of points in the X-Y plane of the travel time data volume and writing the X-Y plane for each Z back to the at least one memory bank and the at least one alternate memory bank;
if a second half step for a single point has been calculated, send the travel time data volume to the at least one memory bank.

2. The method of claim 1, wherein the alternate memory bank is fast access, static memory and the memory bank is bulk, dynamic memory.

3. The method of claim 1, wherein the step of calculating an X-Y plane for each Z for a series of points in the X-Y plane of the travel time data volume and writing the X-Y plane for each Z back to the at least one memory bank and the at least one alternate memory bank comprises:
reading X data for each Y and copying the X data for each Y into the alternate bank of memory;
incrementing Z by Y-size;
reading X slowness data for a current Z-plane and reading the X slowness data for a next Z-plane;
incrementing Y by 1;
reading X data for next Z into the alternate memory bank;
computing minimum;
writing travel data or minimum into the memory bank and maintaining a copy of the travel data or minimum in the alternate memory bank; and
incrementing Z by Y size;
if the X-Y plane for each Z has not been calculated, swap the memory bank and the alternate memory bank and return to reading X data for each Y and copying the X data for each Y into the alternate bank of memory.

4. The method of claim 1, wherein the step of calculating an Z-Y plane for each X in either X direction for a series of points on the Z-Y plane of the travel time data volume and writing the Z-Y plane for each X in either X direction back to the at least one memory bank and the at least one alternate memory bank comprises:
reading Z data for each Y and copying the Z data for each Y into the alternate bank of memory;
incrementing X by +/−Y-size;
reading Z slowness data for a current X-plane and reading the Z slowness data for a next X-plane;
incrementing Y by +/−1;
reading Z data for next X into the alternate memory bank;
computing minimum;
writing travel data or minimum into the memory bank and maintaining a copy of the travel data or minimum in the alternate memory bank; and
incrementing X by +/−Y size;
if the Z-Y plane for each X has not been calculated, swap the memory bank and the alternate memory bank and return to reading Z data for each Y and copying the Z data for each Y into the alternate bank of memory.

5. The method of claim 1, wherein the step of calculating an X-Z plane for each Y in either Y direction for a series of points on the X-Z plane of the travel time data volume and writing the X-Z plane for each Y in either Y direction back to the at least one memory bank and the at least one alternate memory bank comprises:
reading X data for each Z and copying the X data for each Z into the alternate bank of memory;
incrementing Z by +/−Y-size;
reading X slowness data for a current Y-plane and reading the X slowness data for a next Y-plane;
incrementing Y by 1;
reading X data for next Y into the alternate memory bank;
computing minimum;
writing travel data or minimum into the memory bank and maintaining a copy of the travel data or minimum in the alternate memory bank; and
incrementing Z by +/−Y size;
if the X-Z plane for each Y has not been calculated, swap the memory bank and the alternate memory bank and return to reading X data for each Z and copying the X data for each Z into the alternate bank of memory.

6. The method of claim 1, wherein swapping of the axes in the travel time data volume is over the entire travel time data volume.

7. The method of claim 1, wherein the swapping of the axes in the travel time data volume is over a portion of the travel time data volume.

8. A method of implementing a Runge-Kutta integration for generating a travel time half step for a single point defined by X, Y, and Z values along X, Y and Z axes in a travel time data volume comprising: at least one memory bank; at least one alternate memory bank; and at least one decision block interacting with the at least one memory bank and the at least one alternate memory bank comprising the steps of:
calculating an X-Y plane for each Z for a series of points in the X-Y plane of the travel time data volume and writing the X-Y plane for each Z back to the at least one memory bank and the at least one alternate memory bank;
calculating an X-Z plane for each Y in one Y direction for a series of points on the X-Z plane of the travel time data volume and writing to the at least one memory bank and the at least one alternate memory bank as Z-X plane for each Y in either Y direction;
calculating an Z-Y plane for each X in either X direction for a series of points on the Z-Y plane of the travel time data volume and writing the Z-Y plane for each X in either X direction back to the at least one memory bank and the at least one alternate memory bank;
calculating an Z-X plane for each Y in the other Y direction for a series of points on the Z-X plane of the travel time data volume and writing the X-Z plane for each Y in the other Y direction back to the at least one memory bank and the at least one alternate memory bank;
if a second half step for single point has not been calculated, return to calculating an X-Y plane for each Z for a series of points in the X-Y plane of the travel time data volume and writing the X-Y plane for each Z back to the at least one memory bank and the at least one alternate memory bank;
if a second half step for a single point has been calculated, send the travel time data volume to the at least one memory bank.

9. The method of claim 8, wherein the alternate memory bank is fast access, static memory and the memory bank is bulk, dynamic memory.

10. The method of claim 8, wherein the step of calculating an X-Y plane for each Z for a series of points in the X-Y plane of the travel time data volume and writing the X-Y plane for each Z back to the at least one memory bank and the at least one alternate memory bank comprises:
reading X data for each Y and copying the X data for each Y into the alternate bank of memory;
incrementing Z by Y-size;
reading X slowness data for a current Z-plane and reading the X slowness data for a next Z-plane;
incrementing Y by 1;
reading X data for next Z into the alternate memory bank;
computing minimum;
writing travel data or minimum into the memory bank and maintaining a copy of the travel data or minimum in the alternate memory bank; and
incrementing Z by Y size;
if the X-Y plane for each Z has not been calculated, swap the memory bank and the alternate memory bank and return to reading X data for each Y and copying the X data for each Y into the alternate bank of memory.

11. The method of claim 8, wherein the step of calculating an X-Z plane for each Y in one Y direction for a series of points on the X-Z plane of the travel time data volume and writing to the at least one memory bank and the at least one alternate memory bank as Z-X plane for each Y in either Y direction comprises:
reading X data for each Z and copying the X data for each Z into the alternate bank of memory;
incrementing Z by + or −Y-size;
reading X slowness data for a current Y-plane and reading the X slowness data for a next Y-plane;
incrementing Z by +/−1;
reading X data for next Y into the alternate memory bank;
computing minimum;
writing travel data or minimum into the memory bank and maintaining a copy of the travel data or minimum in the alternate memory bank; and
incrementing Z by + or −Y size;
if the Z-X plane for each Y has not been calculated, swap the memory bank and the alternate memory bank and return to reading X data for each Z and copying the X data for each Z into the alternate bank of memory.

12. The method of claim 8, wherein the step of calculating an Z-Y plane for each X in either X direction for a series of points on the Z-Y plane of the travel time data volume and writing the Z-Y plane for each X in either X direction back to the at least one memory bank and the at least one alternate memory bank comprises:
reading Z data for each Y and copying the Z data for each Y into the alternate bank of memory;
incrementing X by +/−Y-size;
reading Z slowness data for a current X-plane and reading the Z slowness data for a next X-plane;
incrementing Y by +/−1;
reading Z data for next X into the alternate memory bank;
computing minimum;
writing travel data or minimum into the memory bank and maintaining a copy of the travel data or minimum in the alternate memory bank; and
incrementing X by +/−Y size;
if the Z-Y plane for each X has not been calculated, swap the memory bank and the alternate memory bank and return to reading Z data for each Y and copying the Z data for each Y into the alternate bank of memory.

13. The method of claim 8, wherein the step of calculating an Z-X plane for each Y in the other Y direction for a series of points on the Z-X plane of the travel time data volume and writing the X-Z plane for each Y in the other Y direction back to the at least one memory bank and the at least one alternate memory bank comprises:
reading Z data for each X and copying the Z data for each X into the alternate bank of memory;
incrementing Z by other + or −Y-size;
reading X slowness data for a current Y-plane and reading the X slowness data for a next Y-plane;
incrementing Z by +/−1;
reading Z data for next Y into the alternate memory bank;
computing minimum;
writing travel data or minimum into the memory bank and maintaining a copy of the travel data or minimum in the alternate memory bank; and
incrementing Z by other + or −Y size;
if the Z-X plane for each Y has not been calculated, swap the memory bank and the alternate memory bank and return to reading X data for each Z and copying the X data for each Z into the alternate bank of memory.

14. A system for transforming data through a Rung-Kutta integration of a single point defined by X, Y, and Z values along X, Y and Z axes from a travel time data volume comprising:
at least one memory bank and at least one alternate memory bank;
at least one single cycle Runge-Kutta travel time generator in communication with the at least one memory bank and the at least one alternate memory bank;
wherein the at least one single cycle Runge-Kutta travel time generator reads data from the at least one memory bank, and transforms the data by performing a Runge-Kutta integration on points of a plane defined by X, Y, and Z values along X, Y and Z axes in a travel time data volume and slowness data to generate another plane of values with the integration carried forward by a half step; and writes the data back to the at least one alternate memory bank.

15. The system of claim 14, further comprising a CPU coupled to the at least one memory bank and the at least one alternate memory bank.

16. The system of claim 14, wherein the data is transformed by two Runge-Kutta travel time generators sequentially.

17. The system of claim 14, wherein the data is transformed by two Runge-Kutta travel time generators operating in parallel.

18. The system of claim 14, wherein the transformation of the data by the Runge-Kutta travel time generator comprises the steps of:
calculating an X-Y plane for each Z for a series of points in the X-Y plane of the travel time data volume and writing the X-Y plane for each Z back to the at least one memory bank and the at least one alternate memory bank;
swapping X and Z axes in the travel time data volume;
calculating an Z-Y plane for each X in either X direction for a series of points on the Z-Y plane of the travel time data volume and writing the Z-Y plane for each X in either X direction back to the at least one memory bank and the at least one alternate memory bank;
swapping Z and X axes in the travel time data volume;
calculating an X-Z plane for each Y in either Y direction for a series of points on the X-Z plane of the travel time data volume and writing the X-Z plane for each Y in either Y direction back to the at least one memory bank and the at least one alternate memory bank;
if a second half step for single point has not been calculated, return to calculating an X-Y plane for each Z for a series of points in the X-Y plane of the travel time data volume and writing the X-Y plane for each Z back to the at least one memory bank and the at least one alternate memory bank;
if a second half step for a single point has been calculated, send the travel time data volume to the at least one memory bank.

19. The system of claim 14, wherein the transformation of the data by the Runge-Kutta travel time generator comprises the steps of:
calculating an X-Y plane for each Z for a series of points in the X-Y plane of the travel time data volume and writing the X-Y plane for each Z back to the at least one memory bank and the at least one alternate memory bank;
calculating an X-Z plane for each Y in one Y direction for a series of points on the X-Z plane of the travel time data volume and writing to the at least one memory bank and the at least one alternate memory bank as Z-X plane for each Y in either Y direction;
calculating an Z-Y plane for each X in either X direction for a series of points on the Z-Y plane of the travel time data volume and writing the Z-Y plane for each X in either X direction back to the at least one memory bank and the at least one alternate memory bank;
calculating an Z-X plane for each Y in the other Y direction for a series of points on the Z-X plane of the travel time data volume and writing the X-Z plane for each Y in the other Y direction back to the at least one memory bank and the at least one alternate memory bank;
if a second half step for single point has not been calculated, return to calculating an X-Y plane for each Z for a series of points in the X-Y plane of the travel time data volume and writing the X-Y plane for each Z back to the at least one memory bank and the at least one alternate memory bank;
if a second half step for a single point has been calculated, send the travel time data volume to the at least one memory bank.

20. A chip implementing a Runge-Kutta integration comprising:
a first port for accepting an input of travel time data for a current plane;
a port for accepting an input of slowness data from a velocity model;
transforming the inputs through a Runge-Kutta integration;
outputting a plane of travel time data with integration carried forward by a
calculating an X-Y plane for each Z for a series of points in the X-Y plane of the travel time data;
swapping X and Z axes in the travel time data volume;
calculating an Z-Y plane for each X in either X direction for a series of points on the Z-Y plane of the travel time data volume;
swapping Z and X axes in the travel time data volume;
calculating an X-Z plane for each Y in either Y direction for a series of points on the X-Z plane of the travel time data volume;
if a second half step for single point has not been calculated, return to calculating an X-Y plane for each Z for a series of points in the X-Y plane of the travel time data volume.

21. The chip of claim 19, further comprising an input of the output of a plane of travel time data with integration carried forward by a first half step.
